(19) United States
(12) Patent Application Publication
(10) Pub. No.: US 2006/0197854 A1
(43) Pub. Date: Sep. 7, 2006

(54) Image capturing apparatus and computer software product

(75) Inventor: Hiroaki Kubo, Muko-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/215,384

(22) Filed: Aug. 30, 2005

(30) Foreign Application Priority Data
Mar. 3, 2005 (JP) JP2005-058702

(51) Int. Cl. H04N 9/64; H04N 5/217

(52) U.S. Cl. 348/246; 348/241

(57) ABSTRACT

An imaging device from which charge signals accumulated in a light receiving part having a pixel array divided into a plurality of fields can be read out is used. In a predetermined image capturing mode such as a MOVE mode, high-speed continuous-exposure mode or live view mode, a captured image is generated only by using charge signals read out from at least one field having a relatively small number of defective pixels.

This application is based on application No. 2005-58702 filed in Japan, the contents of which are hereby incorporated by reference.

### BACKGROUND OF THE INVENTION

1. Field of the Invention

The present invention relates to an image capturing apparatus.

2. Description of the Background Art

CCDs are generally used as imaging devices for digital cameras. In recent years, such CCDs have been made smaller in size and higher in pixel density. Following this, the number of defects in pixels (defective pixels) occurring in the CCDs has been growing.

Such defective pixels result in, for example, high luminance spots (point defects) in an image captured by a CCD.

Proposed to control the influence caused by point defects to obtain a good still image is a technique for conducting interpolation using pixel values of a plurality of neighboring pixels of a defective pixel at the time of still image capturing while replacing a pixel value of a defective pixel only by a pixel value of an adjacent pixel of the same color (pre-interpolation) at the time of motion picture capturing (e.g., Japanese Patent Application Laid-Open No. 2000-224490). With this technique, data (address data) indicative of the location of pixels having defects (defective pixels) is previously recorded in a predetermined memory, so that the influence of point defects can also be controlled when capturing a motion picture at short frame intervals.

However, the above-described technique causes image degradation by the pre-interpolation in motion picture capturing.

Considering a case of displaying a motion picture having a relatively small number of pixels, point defects occupy a large area in an image, which thus tend to show up clearly. On the other hand, assuming as a precondition that point defects are subjected to interpolation, it takes longer time to perform the interpolation with an increase in the number of point defects, causing a problem in that the interpolation does not catch up with the frame rate.

### SUMMARY OF THE INVENTION

The present invention is directed to an image capturing apparatus.

According to the present invention, the image capturing apparatus comprises: an image capturing part including an imaging device having a light receiving part from which charge signals accumulated in the light receiving part can be read out, the light receiving part having a pixel array divided into a plurality of fields; a memory for storing at least one location of a defective pixel in the imaging device; a mode selector for selecting a predetermined image capturing mode from among a plurality of image capturing modes; a designating part for designating at least one field among the plurality of fields that has a relatively small number of defective pixels on the basis of the at least one location of the defective pixel stored in the memory; and a generator for generating a captured image only by using charge signals read out from the at least one field with the predetermined image capturing mode being selected.

A captured image is generated using a group of charge signals originally including few abnormal charge signals which result from defective pixels. This can reduce the number of point defects to be corrected as well as a time required for correcting such point defects. As a result, an image less affected by point defects can be obtained at high speeds.

The present invention is also directed to a computer software product.

It is therefore an object of the present invention to provide a technique capable of obtaining an image less affected by point defects at high speeds.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1C show the construction of main components of an image capturing apparatus according to a preferred embodiment of the present invention;

FIG. 2 is a functional block diagram of the image capturing apparatus according to the preferred embodiment;

FIG. 3 shows how to read out a charge signal in a CCD;

FIGS. 4 and 5 each show how a point defect occurs;

FIG. 6 shows how to correct the point defect;

FIG. 7 shows how to read out a charge signal;

FIG. 8 is a flowchart showing the process of detecting a point defect;

FIG. 9 is a flowchart showing the process of switching a readout field;

FIG. 10 is a flowchart showing the process of image capturing;

FIG. 11 shows how to read out a charge signal according to a variant of the invention;

FIGS. 12 and 13 are functional block diagrams each showing an image capturing apparatus according to the variant; and

FIG. 14 shows weighting when judging the amount of point defects.

### DESCRIPTION OF THE PREFERRED EMBODIMENTS

Hereinafter, a preferred embodiment of the present invention will be described in reference to the accompanied drawings.

Outline of Image Capturing Apparatus

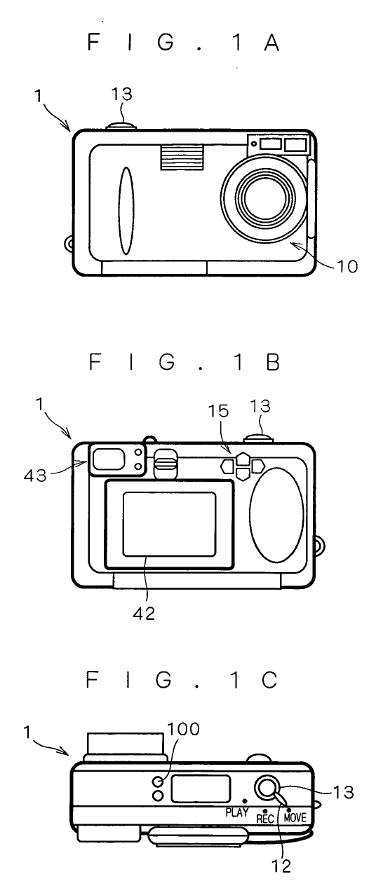

FIGS. 1A to 1C show the construction of main components of an image capturing apparatus 1 according to a preferred embodiment of the present invention. FIG. 1A is a front view, FIG. 1B is a rear view and FIG. 1C is a top view of the image capturing apparatus 1.

The image capturing apparatus 1 is constructed as a digital camera, and includes a taking lens device 10.

The image capturing apparatus 1 has a mode switch 12, a shutter-release button 13 and a power button 100 on its top face.

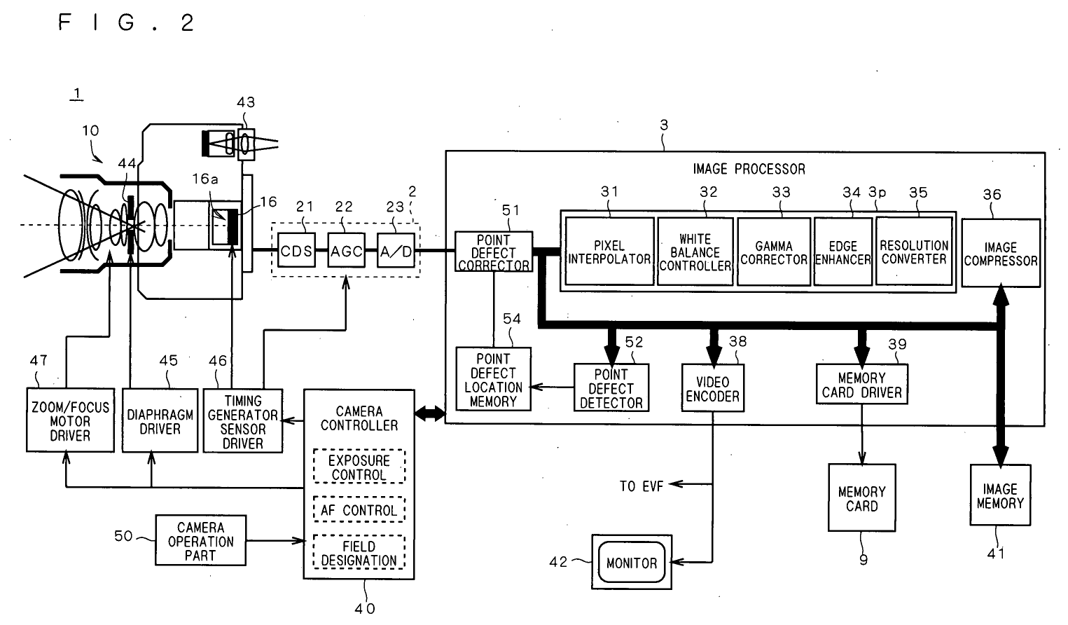

The mode switch 12 is a switch for switching among a still image capturing mode (REC mode) for capturing an image of a subject and recording a still image of the subject, a moving picture capturing mode (MOVE mode) for capturing a moving picture and a playback mode (PLAY mode) for playing back an image recorded on a memory card 9 (see FIG. 2).

The shutter-release button 13 is a two-step switch enabling detection of a half-pressed state (S1 on state) and a full-pressed state (S2 on state). When the shutter-release button 13 is pressed halfway in the REC mode, a zoom/focus motor driver 47 (see FIG. 2) is driven to shift the taking lens device 10 to a position where focus is achieved (AF operation). In the S1 on state, exposure control by a camera controller 40 (see FIG. 2) is performed concurrently.

When the shutter-release button 13 is full-pressed in the REC mode, actual image capturing, that is, image capturing for recording is performed. When the shutter-release button 13 is full-pressed in the MOVE mode, moving picture capturing is started in which actual image capturing is performed repeatedly to obtain a moving picture, and when the shutter-release button 13 is full-pressed again, the moving picture capturing is finished. When the shutter-release button 13 is full-pressed in a high-speed continuous-exposure mode which will be described later, actual image capturing is started and performed several times at a predetermined frame rate while the shutter-release button 13 is kept full-pressed.

The power button 100 is a button for turning on/off the image capturing apparatus 1. By pressing the power button 100, the image capturing apparatus 1 can be turned on and off alternately.

On the rear face of the image capturing apparatus 1, an LCD (liquid crystal display) monitor 42 for displaying a captured image or the like, an electronic viewfinder (EVF) 43 and a frame-advance/zoom switch 15 are provided.

The frame-advance/zoom switch 15 is a switch composed of four buttons for instructing advancing of frames of recorded images in the PLAY mode and zooming at the time of image capturing. By the operation of the frame-advance/zoom switch 15, the zoom/focus motor driver 47 is driven so that a focal length of the taking lens device 10 can be changed.

In the REC mode, switching can be made between a mode for obtaining a still image of one frame (normal image capturing mode) and a mode for carrying out continuous exposures at high frame rates (high-speed continuous-exposure mode) by pressing left or right button of the frame-advance/zoom switch 15.

In the REC mode and MOVE mode, the image capturing apparatus 1 is first brought into an image-capturing standby state before image capturing for acquiring a captured image to be recorded (actual image capturing). In this image-capturing standby state, captured image data for preview (live view image) is visually output on the LCD monitor 42 or EVF 43 as a moving picture. Thus, it can be considered that a mode for obtaining a live view image (live view mode) is selected in the image-capturing standby state in the REC mode and MOVE mode.

In other words, in the image capturing apparatus 1, the REC mode includes the normal image capturing mode and high-speed continuous-exposure mode. The normal image capturing mode and high-speed continuous-exposure mode each include the live view mode. The MOVE mode also includes the live view mode.

Functional Configuration of Image Capturing Apparatus

FIG. 2 is a functional block diagram of the image capturing apparatus 1.

The image capturing apparatus 1 includes an imaging sensor 16, a signal processor 2 connected to the imaging sensor 16 such that data can be transmitted thereto, an image processor 3 connected to the signal processor 2 and a camera controller 40 connected to the image processor 3.

The imaging sensor (CCD) 16 is constructed as an area sensor (imaging device) in which primary-color transmission filters of a plurality of color components, R (red), G (green) and B (blue) are arrayed in a checkered pattern (Bayer pattern) to cover corresponding pixels.

Upon completing accumulation of electric charge by exposure in the CCD 16, a photoelectrically-converted charge signal is shifted to a vertical/horizontal transmission path shielded from light within the CCD 16, and is output as an image signal through a buffer. That is, the CCD 16 serves as imaging means for acquiring an image signal (image) of a subject.

The CCD 16 has a light receiving part 16a on a surface facing the taking lens device 10, and a plurality of pixels are arrayed in the light receiving part 16a. The pixel array constituting the light receiving part 16a is divided into three fields. The CCD 16 is configured such that a charge signal (image signal) accumulated in each pixel is successively read out from each field.

How to read out a charge signal in the CCD 16 will be discussed now.

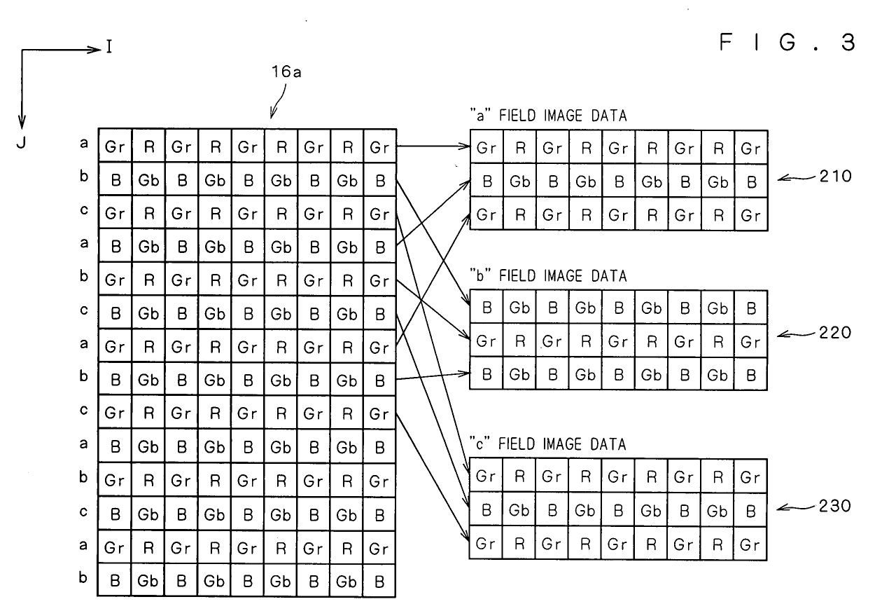

FIG. 3 shows how to read out a charge signal in the CCD 16. More than several millions of pixels are actually arrayed in the light receiving part 16a of the CCD 16, however, only part of them are shown for ease of illustration. In FIG. 3, two axes I and J respectively indicating the horizontal and vertical directions perpendicular to each other are provided to clearly express the location of pixels in the vertical and horizontal directions in the light receiving part 16a.

As shown in FIG. 3, a color filter array corresponding to the pixel array is provided in the light receiving part 16a. Conversely, the light receiving part 16a has a color filter array. This color filter array is made up of periodically-distributed color filters of red (R), green (Gr, Gb) and blue (B), i.e., three kinds of color filters having different colors from each other.

In the CCD 16, as shown in FIG. 3, the 1st, 4th, 7th . . . horizontal lines (assigned “a” in the drawing) arranged in the direction J in the light receiving part 16a, i.e., the (3n+1)-th line (where n is an integer) shall belong to an “a” field. Also, the 2nd, 5th, 8th . . . horizontal lines (assigned “b” in the drawing) arranged in the direction J in the light receiving part 16a, i.e., the (3n+2)-th line (where n is an integer) shall belong to a “b” field. Further, the 3rd, 6th, 9th . . . horizontal lines (assigned “c” in the drawing) arranged in the direction J in the light receiving part 16a, i.e., the (3n+3)-th line (where n is an integer) shall belong to a “c” field.

In this manner, dividing the light receiving part 16a into three fields allows each of the “a” to “c” fields to include all the color components of the color filter array, that is, pixels of all the RGB colors covered with all the RGB color filters.

In the case of reading out a charge signal accumulated in each cell of the CCD 16 in actual image capturing in the normal image capturing mode in the still image capturing mode, charge signals are read out from the “a” field to be collected into “a” field image data 210, as shown in FIG. 3. Next, charge signals are read out from the “b” field to be collected into “b” field image data 220. Finally, charge signals are read out from the “c” field to be collected into “c” field image data 230. In this manner, charge signals are read out from all the pixels arrayed in the light receiving part 16a.

On the other hand, in the high-speed continuous-exposure mode in the still image capturing mode, actual image capturing in the MOVE mode and the live view mode, charge signals are read out from one of the “a” to “c” fields that is designated by a field designating function (which will be described later). In other words, charge signals are read out from one in every three horizontal lines.

The signal processor 2 includes a CDS 21, an AGC 22 and an A/D converter 23, and serves as a so-called analog front end.

An analog image signal output from the CCD 16 is subjected to sampling in the CDS 21 for noise reduction, and is multiplied by an analog gain which corresponds to image capturing sensitivity in the AGC 22 for making sensitivity correction.

The A/D converter 23 is constructed as a 14-bit converter, and converts an analog signal normalized in the AGC 22 into a digital image signal. The digital image signal is subjected to predetermined image processing in the image processor 3, so that an image file is generated.

The image processor 3 includes a point defect corrector 51, a digital processor 3p, an image compressor 36, a video encoder 38, a memory card driver 39, a point defect detector 52 and a point defect location memory 54.

Image data input to the image processor 3 is first subjected to point defect interpolation in the point defect corrector 51 in which data of a defective pixel is replaced by correction data on the basis of a point defect address previously recorded on the point defect location memory 54.

Now, how a point defect occurs and how to interpolate the point defect will be described.

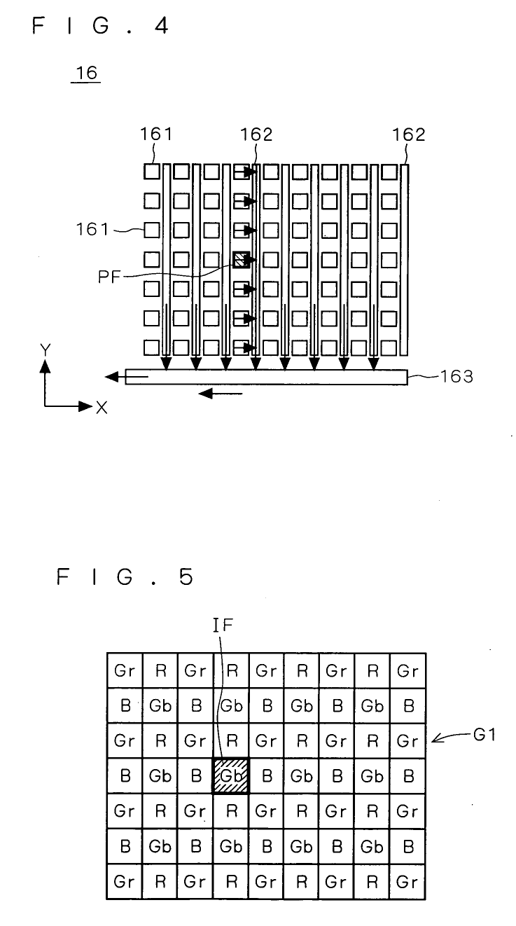

FIGS. 4 and 5 each show how a point defect occurs. FIG. 4 shows the configuration of the CCD 16 having a defective pixel, and FIG. 5 shows a pixel indicating an abnormal pixel value (point defect) resulting from the defective pixel in an image acquired by the CCD 16.

In the CCD 16 shown in FIG. 4, a charge signal photoelectrically converted by each photodiode 161 and accumulated is read out and input to a vertical CCD (also referred to as a “VCCD”) 162 provided for each vertical transmission line, and is transmitted to a horizontal CCD 163 on the lowermost stage. The charge signal transmitted to the horizontal CCD 163 is read out on the basis of a pixel clock, so that readout in the horizontal pixel direction is performed. Lines for transmitting charge signals such as the VCCD 162 and horizontal CCD 163 are also generically called a “charge transmission line”.

By the function of the CCD 16, each horizontal line is scanned to read out a two-dimensional image obtained by photodiodes 161 arrayed two-dimensionally.

In the case where a photodiode 161 has a defect, electric charge caused by the defect is added to signal charge, causing the defect to show up again in a captured image as a point defect. For instance, when a photodiode PF has a defect as shown in FIG. 4, a pixel (point defect) IF indicating an abnormally high pixel value (high luminance) shows up in a captured image GI as shown in FIG. 5.

Since the occurrence of such point defect degrades image quality of a captured image, point defect interpolation using a pixel value of a neighboring pixel of the same color is performed in the point defect corrector 51.

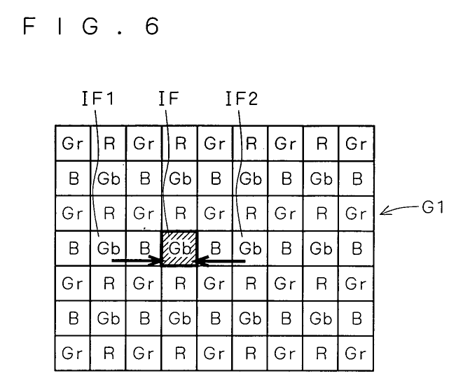

FIG. 6 shows how to interpolate the point defect.

As shown in FIG. 6, when the point defect IF shows up in the captured image GI, a mean value of pixel values of left and right pixels IF1 and IF2 having the same color as and most adjacent to the point defect IF is calculated in the point defect corrector 51. Then, pixel data of the point defect is replaced by data indicative of the mean value as correction data.

More specifically, when the pixel IF of green (Gb) is a point defect, a mean value of the pixel values of the left and right pixels IF1 and IF2 having the same color as and most adjacent to the point defect IF is given as pixel data of the point defect.

The point defect corrector 51 performs normal point defect correction of performing interpolation when pixel data received from the signal processor 2 is of a pixel corresponding to the location of the point defect recorded on the point defect location memory 54.

However, with an increase in point defects, the number of point defect interpolation also increases, and corrected point defects tend to cause degradation in image quality. Particularly in the case of a motion picture, a live view image or the like whose image data contains a relatively small number of pixels, pixel skipping is performed at the time of image capturing. Thus, the influence of defective pixels tends to become greater than in a captured image generated using pixel values of all pixels.

The digital processor 3p has a pixel interpolator 31, a white balance controller 32, a ganima corrector 33, an edge enhancer 34 and a resolution converter 35.

Image data input to the digital processor 3p is written into the image memory 41 in synchronization with the readout in the CCD 16. Thereafter, image data stored in the image memory 41 is accessed and subjected to various types of processing in the digital processor 3p.

Each of RGB pixels of the image data stored in the image memory 41 is independently subjected to gain correction by the white balance controller 32, for white balance correction of RGB. In the white balance correction, a part which is inherently white is estimated from a subject on the basis of luminance, color saturation data and the like, and respective mean values of R, G and B pixels, a G/R ratio and a G/B ratio of that portion are obtained. On the basis of the information, the data is controlled as correction gains of R and B.

In the pixel interpolator 31, the R, G and B pixels are masked with corresponding filter patterns, respectively. Then, referring to G pixels having pixel values up to a high frequency band, spatial variations in pixel value are estimated on the basis of, for example, a contrast pattern of neighboring twelve pixels of a target G pixel to calculate an optimum value suitable for a pattern of a subject on the basis of data of neighboring four pixels, thereby assigning the optimum value to the target G pixel. R and B pixels are respectively interpolated on the basis of pixel values of neighboring eight pixels of the same color.

The pixel-interpolated image data is subjected to nonlinear conversion in the gamma corrector 33 in accordance with an output device, specifically, gamma correction and offset adjustment, and the resultant data is stored in the image memory 41.

The edge enhancer 34 performs edge enhancement for enhancing the edge of an image by a high-pass filter and the like in accordance with image data.

Then, the image data stored in the image memory 41 is subjected to horizontal and vertical reduction or skipping of the number of pixels determined in the resolution converter 35, and is compressed in the image compressor 36. The compressed data is recorded on the memory card 9 inserted in the memory card driver 39. At the time of image recording, a captured image of a specified resolution is recorded. The resolution converter 35 also performs pixel skipping at the time of image display, to generate a low-resolution image to be displayed on the LCD monitor 42 or EVF 43. At the time of preview, a low-resolution image of 640×240 pixels read out from the image memory 41 is encoded to an NTSC/PAL image in the video encoder 38. By using the encoded data as a field image, an image is played back on the LCD monitor 42 or EVF 43.

The camera controller 40 includes CPU, ROM, RAM and the like, and controls respective sections of the image capturing apparatus 1. The CPU reads and executes a predetermined program stored in the ROM to cause the camera controller 40 to achieve various kinds of control and functions.

More specifically, the camera controller 40 processes an operation input made by a user to the camera operation part 50 including the above-described mode switch 12, shutter-release button 13, frame-advance/zoom switch 15 and the like. The camera controller 40 also makes switching among the REC mode for capturing an image of a subject and recording image data thereof, MOVE mode and PLAY mode by a user's operation of the mode switch 12. Further, in the REC mode, one of the normal image capturing mode and high-speed continuous-exposure mode is selected in response to a user's operation of the frame-advance/zoom switch 15. Further, in the image-capturing standby state, the live view mode is selected under the control of the camera controller 40.

At the time of preview (live view display) for displaying a subject on the LCD monitor 42 as a moving picture in the image-capturing standby state before actual image capturing, an optical lens aperture of a diaphragm 44 is kept open by a diaphragm driver 45 in the image capturing apparatus 1. With respect to charge accumulation time (exposure time) of the CCD 16 corresponding to the shutter speed (SS), the camera controller 40 computes exposure control data on the basis of a live view image obtained by the CCD 16. On the basis of a preset program chart and the calculated exposure control data, feedback control is provided for a timing generator sensor driver 46 such that the exposure time of the CCD 16 becomes proper.

Then, in actual image capturing, by the function of the camera controller 40, AE control is executed in which the amount of exposure to be given to the CCD 16 is controlled by the diaphragm driver 45 and timing generator sensor driver 46 on the basis of a preset program chart and light amount data measured using a live view image obtained by the CCD 16.

Referring to an auto-focusing (AF) operation performed by the taking lens device 10, a so-called contrast-type AF control is performed using a live view image obtained by the CCD 16 by the function of the camera controller 40. More specifically, the camera controller 40 calculates, on the basis of a live view image, such a position of the taking lens device 10 that the contrast in a main subject reaches its highest, as an in-focus lens position that achieves focus on the main subject. Then, a focus lens element in the taking lens device 10 is shifted to the in-focus lens position by the zoom/focus motor driver 47.

The point defect detector 52 detects the location address of a point defect on the basis of image data input to the image processor 3 from the signal processor 2. When detecting the location address of a point defect, image data input to the image processor 3 from the signal processor 2 is directly transmitted to the point defect detector 52 without being subjected to interpolation by the point defect corrector 51. The detection of a point defect, that is, detection of the location of a point defect in the CCD 16 is performed with predetermined timing, which will be discussed later.

The point defect location memory 54 records the location address of a point defect detected by the point defect detector 52. Then, the camera controller 40 refers to the location address of a point defect recorded on the point defect location memory 54 to designate one of the “a” to “c” fields that has the fewest point defects (least defective field), and records the least defective field on the ROM.

Then, by the function of the camera controller 40, the least defective field is designated as a field from which charge signals are to be read out (readout field) in accordance with the mode selected in the image capturing apparatus 1. For instance, when the MOVE mode, high-speed continuous-exposure mode or live view mode is selected, image data having a small number of pixels needs to be read out at high frame rates. In that case, charge signals are read out from one of the three fields to ensure high frame rates. Then, in the image capturing apparatus 1, image data (an image) is generated by the image processor 3 only using charge signals read out from the least defective field of the CCD 16.

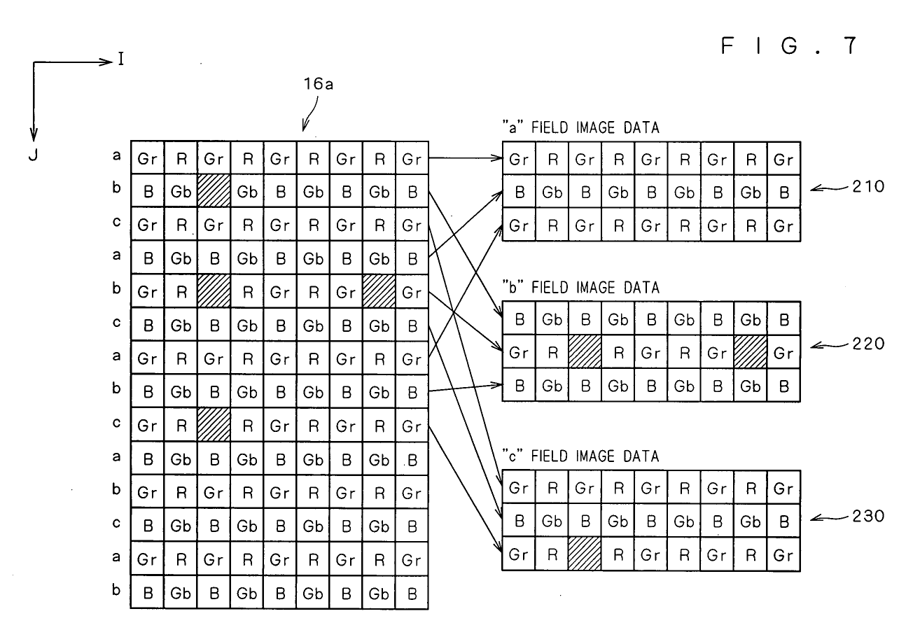

FIG. 7 generally shows how to read out charge signals from the least defective field. FIG. 7 differs from FIG. 3 in that hatched portions indicating defective pixels are added.

As shown in FIG. 7, in the case where the “a” field is the least defective field among the “a” to “c” fields, the “a” field is designated as a readout field.

Point defect detection, least defective field designation, readout field designation and image capturing in the image capturing apparatus 1 of the above-described configuration will be discussed now.

Point Defect Detection and Least Defective Field Designation

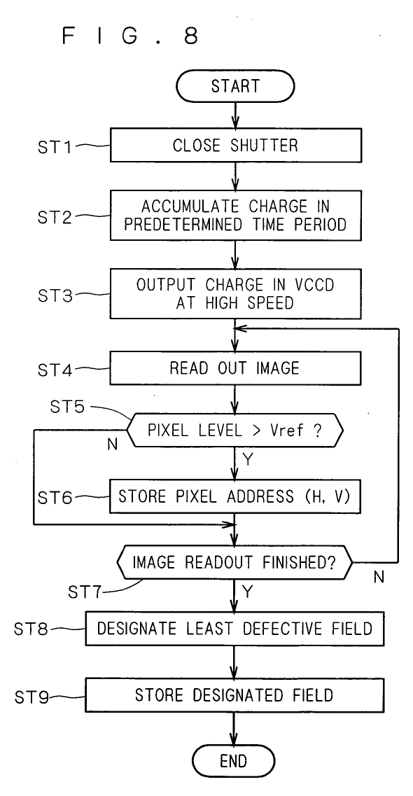

FIG. 8 is a flowchart showing the process of detecting a point defect. This process is conducted under the control of the camera controller 40 when the main switch 100 is pressed to turn off the image capturing apparatus 1.

First, the diaphragm 44 corresponding to a shutter is closed (step ST1).

In step ST2, charge signals are accumulated only for a predetermined time period (charge signal accumulation) with the shutter kept closed. A pixel in which a charge signal is accumulated among pixels arrayed in the light receiving part 16a during the charge signal accumulation for the predetermined time period is a pixel having a defect (defective pixel) in which an abnormal charge signal is accumulated due to a factor other than light illumination since the shutter is so closed that light is not illuminated on the light receiving part 16a.

In step ST3, charge signals are output at high speeds in the vertical transmission path (VCCD) 162.

In step ST4, pixel data is successively read out from the CCD 16.

In step ST5, it is judged whether the level of pixels read out in step ST4 is higher than a preset defect level reference (threshold) Vref. When the pixel level is higher than the defect level reference Vref, the process proceeds into step ST6, and when it is lower than or equal to the defect level reference Vref, the process proceeds into step ST7. The point defect detector 52 detects a pixel of level higher than the defect level reference Vref as a point defect.

In step ST6, an address (H, V) on an image of the point defect having a level higher than the defect level reference Vref is stored in the point defect location memory 54.

In step ST7, it is judged whether image readout from the CCD 16 is completed. When image readout is completed, the process proceeds into step ST8, and when not completed, the process returns to step ST4.

In step ST8, one of the “a” to “c” fields having the fewest point defects, that is, fewest defective pixels is designated as the least defective field by referring to addresses of point defects stored in the point defect location memory 54.

In step ST9, the least defective field designated in step ST8 is recorded on the ROM in the camera controller 40, and the process is finished.

Such point defect detection and least defective field designation is performed before shipment from a plant, and also performed each time the image capturing apparatus 1 is turned off. In other words, the location of a defective pixel stored in the point defect location memory 54 is updated to the location of a defective pixel detected whenever necessary by the point defect detector 52.

Readout Field Designation

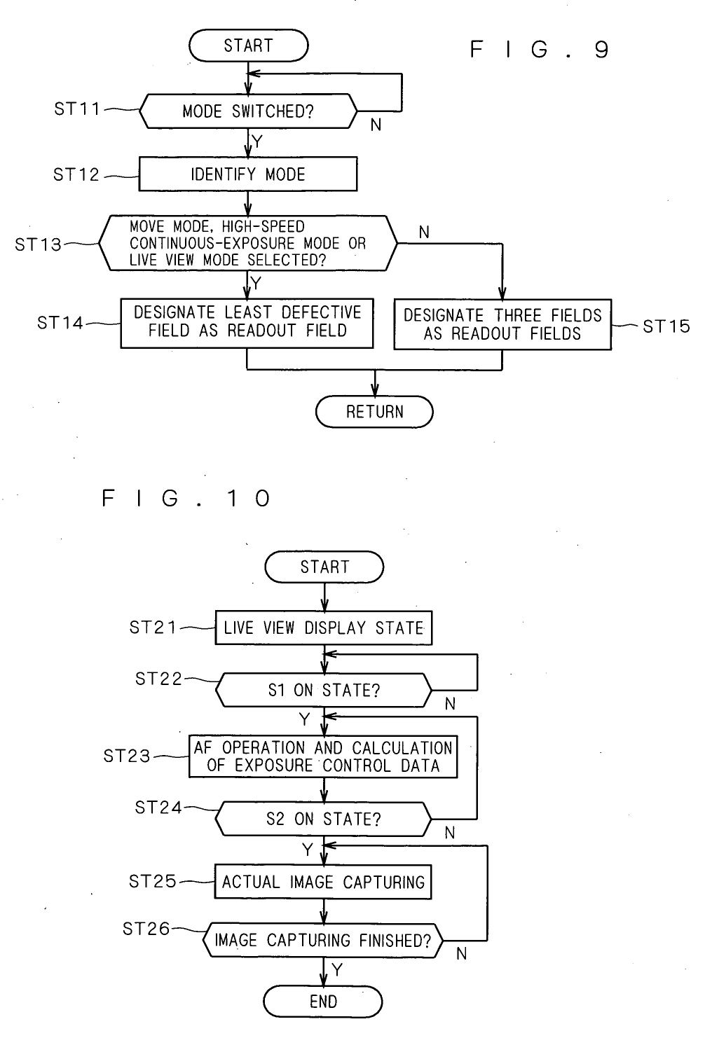

FIG. 9 is a flowchart showing the process of designating a readout field. This process is always conducted under the control of the camera controller 40 while the image capturing apparatus 1 is kept on.

In step ST11, it is judged whether or not mode switching has been made in the image capturing apparatus 1. The judgment in step ST11 is repeated until mode switching is made, and when mode switching is made, the process proceeds into step ST12.

In step ST12, a mode selected in the image capturing apparatus 1 is identified.

In step ST13, it is judged whether or not one of the MOVE mode, high-speed continuous-exposure mode and live view mode is selected in the image capturing apparatus 1. When one of these modes is selected, the process proceeds into step ST14. When neither of these modes is selected, that is, when the normal image capturing mode is selected, the process proceeds into step ST15.

In step ST14, the least defective field recorded on the ROM in the camera controller 40 is designated as a readout field.

In step ST15, all the three “a” to “c” fields are designated as readout fields.

The readout field/fields designated in step ST14 or ST15 is/are recorded on the ROM in the camera controller 40. Then, the process returns to step ST11. In other words, this process is repeated as long as the image capturing apparatus 1 is kept on.

Image Capturing

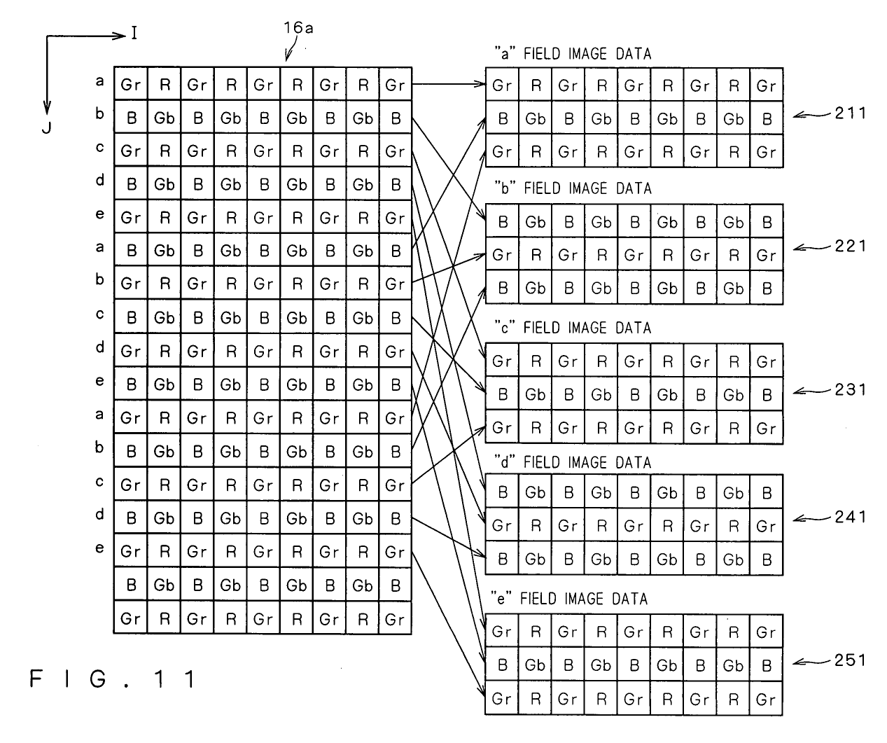

FIG. 10 is a flowchart showing the process of image capturing in the image capturing apparatus 1. This process is started when the MOVE mode or REC mode is selected in the image capturing apparatus 1.

In step ST21, the live view display state is selected. In this live view display state, the image capturing apparatus 1 is brought into the live view mode.

In the live view mode, charge signals are read out only from the least defective field among the “a” to “c” fields per 1/30 second. Then, a live view image is generated only using charge signals read out from the least defective field, and is visually output to the LCD monitor 42 or EVF 43.

In step ST22, it is judged whether or not the shutter-release button 13 is half-pressed (S1 on state). The judgment in step ST22 is repeated until the S1 on state is brought about. When the S1 on state is brought about, the process proceeds into step ST23.

In step ST23, AF operation and calculation of exposure control data are performed. In this case, a live view image obtained from a field having a relatively small number of defective pixels is used for the AF operation and calculation of exposure control data. In other words, the AF operation and calculation of exposure control data are performed using image data of good image quality, so that the AF operation and AE control are improved in accuracy.

In step ST24, it is judged whether or not the shutter-release button 13 is full-pressed (S2 on state). The steps ST23 and ST24 are repeated until the S2 on state is brought about, and when the S2 on state is brought about, the process proceeds into step ST25.

In step ST25, actual image capturing is performed. When the normal image capturing mode is selected, all the three fields are designated as readout fields as shown in step ST15 of FIG. 9. Then, a captured image is generated by combining charge signals read out from the “a” to “c” fields, and is recorded on the memory card 9.

On the other hand, when the MOVE mode or high-speed continuous-exposure mode is selected, the least defective field is designated as a readout field. For instance, as shown in FIG. 7, when the “a” field is the least defective field among the “a” to “c” fields, the “a” field is designated as a readout field. Then, a captured image is generated only using charge signals read out from the “a” field, and is recorded on the memory card 9.

In step ST26, it is judged whether or not image capturing is finished. For instance, when the MOVE mode is selected, it is judged that image capturing is finished when the shutter-release button 13 is full-pressed (S2 on state) again. That is, steps ST25 and ST26 are repeated until the S2 on state is brought about again, and when the S2 on state is brought about again, image capturing is finished. The process is thereby finished.

When the high-speed continuous-exposure mode is selected, it is judged that image capturing is finished when the full-press state (S2 on state) of the shutter-release button 13 is released. That is, the step ST25 and ST26 are repeated until the S2 on state is released, and when the S2 on state is released, image capturing is finished. The process is thereby finished.

When the normal image capturing mode is selected, the process does not return to step ST25. In this case, it is judged that image capturing is finished when image data obtained by actual image capturing in step ST25 is stored in the memory card 9. The process is thereby finished.

As described, the image capturing apparatus 1 according to the preferred embodiment of the present invention uses the CCD 16 from which charge signals accumulated in the light receiving part 16a having the pixel array divided into three fields can be read out. In one of the MOVE mode, high-speed continuous-exposure mode and live view mode, a captured image is generated only using charge signals read out from the least defective field having the fewest defective pixels. With such arrangement, a captured image can be generated using a group of charge signals originally including few abnormal charge signals which result from defective pixels. This can reduce the number of point defects to be corrected as well as the time required for correcting such point defects. As a result, an image less affected by point defects can be obtained at high speeds.

Particularly in a mode requiring image capturing at relatively high frame rates such as the MOVE mode, high-speed continuous-exposure mode or live view mode, an image less affected by point defects can be obtained. Further, in the live view mode, for example, image data necessary for AF operation and AE control can also be obtained from image data less affected by point defects, so that AF operation and AE control can be improved in accuracy.

When the image capturing apparatus 1 is turned off, the location of defective pixels in the CCD 16 is detected, and is reflected in designating the least defective field having the fewest defective pixels. With such arrangement, an image less affected by point defects can be obtained at high speeds whenever necessary.

Variant

The preferred embodiment of the present invention has been described above, however, the present invention is not limited to the above description.

For instance, the least defective field having the fewest defective pixels among the three fields is designated as a readout field in the above-described embodiment, however, this is only an illustrative example. For example, two fields both having a relatively small number of defective pixels may be designated as readout fields.

More generally, similar effects obtained by the above preferred embodiment can also be achieved when a captured image is generated by using the CCD 16 from which charge signals accumulated in the light receiving part 16a having a pixel array divided into a plurality of fields can be read out and as well as only using charge signals read out from at least one of the plurality of fields that has a relatively small number of defective pixels.

The pixel array of the light receiving part 16a may be divided into five fields by way of example, rather than three.

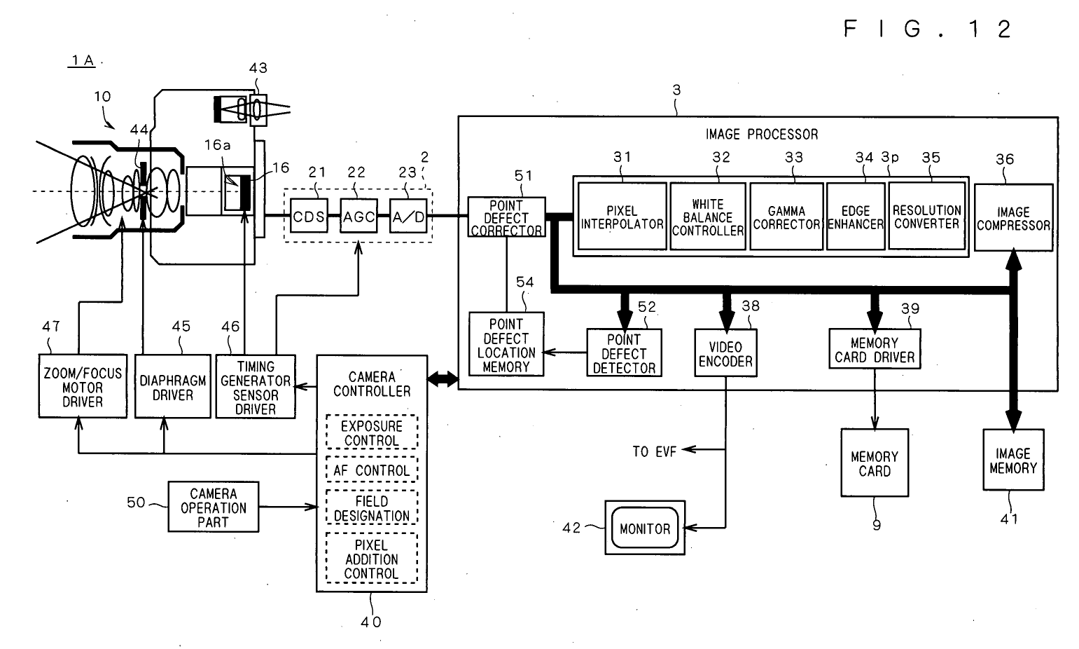

FIG. 11 shows the CCD 16 in which charge signals accumulated in the light receiving part 16a divided into five fields are read out. In FIG. 11, only part of the light receiving part 16a is shown, and two axes I and J extending perpendicular to each other are provided, similarly to FIG. 3.

As shown in FIG. 11, the 1st, 6th, 11th . . . horizontal lines (assigned “a” in the drawing) arranged in the direction J in the light receiving part 16a, that is, the (5n+1)-th line (where n is an integer) shall belong to the “a” field. Also, the 2nd, 7th, 12th . . . horizontal lines (assigned “b” in the drawing), that is, the (5n+2)-th line (where n is an integer) arranged in the direction J in the light receiving part 16a shall belong to the “b” field. The 3rd, 8th, 13th . . . horizontal lines (assigned “c” in the drawing), that is, the (5n+3)-th line (where n is an integer) arranged in the direction J in the light receiving part 16a shall belong to the “c” field. The 4th, 9th, 14th, . . . horizontal lines (assigned “d” in the drawing), that is, the (5n+4)-th line (where n is an integer) arranged in the direction J in the light receiving part 16a shall belong to a “d” field. Further, the 5th, 10th, 15th, . . . horizontal lines (assigned “e” in the drawing), that is, the (5n+5)-th line (where n is an integer) arranged in the direction J in the light receiving part 16a shall belong to an “e” field.

In this manner, dividing the light receiving part 16a into five fields allows each of the “a” to “e” fields to include all the color components of the color filter array, that is, pixels of all the RGB colors provided with all the RGB color filters.

In the case of reading out a charge signal accumulated in each cell of the CCD 16 in actual image capturing in the normal image capturing mode of the still image capturing mode, charge signals are read out from the “a” field to be collected into “a” field image data 211, as shown in FIG. 11. Next, charge signals are read out from the “b” field to be collected into “b” field image data 221. Then, charge signals are read out from the “c” field to be collected into “c” field image data 231. Further, charge signals are read out from the “d” field to be collected into “d” field image data 241. Finally, charge signals are read out from the “e” field to be collected into “e” field image data 251. In this manner, charge signals are read out from all the pixels arrayed in the light receiving part 16a.

In the above-described preferred embodiment, a captured image is generated simply by reading out charge signals of some of the plurality of fields. However, this is only an illustrative example, and charge signals of two or more fields may be added to each other.

Specifically, as shown in FIG. 3, in the case of using the CCD 16 in which charge signals are read out from the light receiving part 16a divided into three fields, charge signals of two fields, i.e., the “a” and “c” fields having the fewest defective pixels may be added to each other by the VCCD 162. More specifically, charge signals of pixels of the same color located most adjacent to each other in the vertical direction among pixels of the same color in the “a” and “c” fields may be added to each other. With such arrangement, a captured image such as synthesized two pieces of images of high quality both having a relatively small number of point defects can be obtained. With such pixel addition related to a plurality of pixels, the sensitivity can be increased while reducing the occurrence of moiré. Further, similarly to the above-described preferred embodiment, an image less affected by point defects can also be obtained at high speeds.

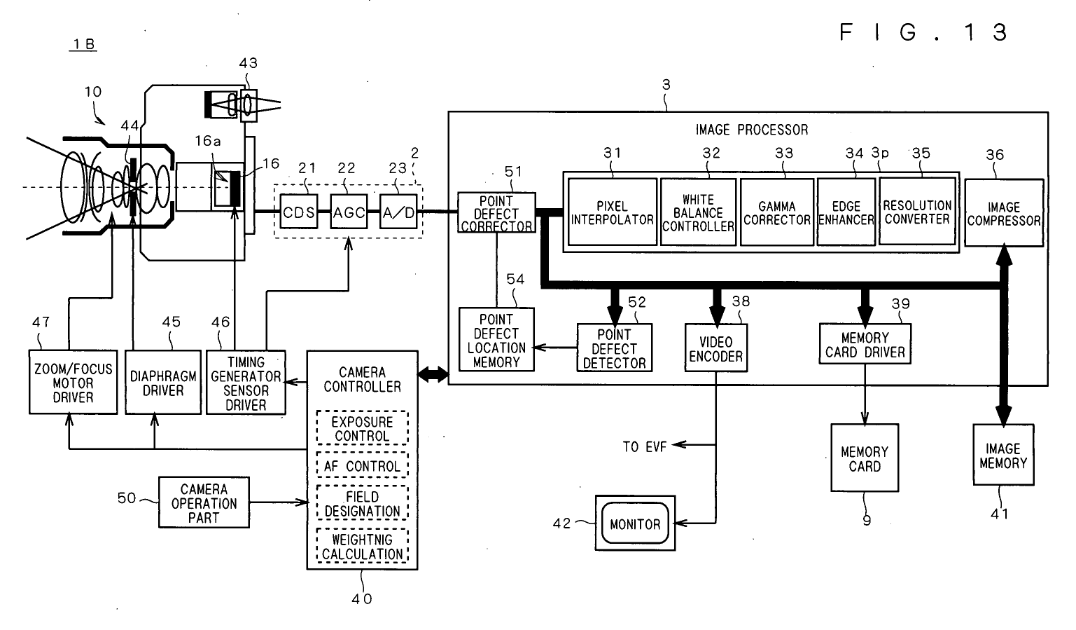

Such arrangement can be achieved in an image capturing apparatus 1A having the camera controller 40 shown in FIG. 2 provided with an additional function of exerting control to perform addition of charge signals, i.e., pixel addition in the CCD 16, as shown in FIG. 12. In this case, the CCD 16 needs to be arranged such that charge signals can be added in the VCCD 162.

Further, such pixel addition is not limited to adding charge signals of a plurality of pixels arrayed in the vertical direction to each other, but charge signals of a plurality of pixels arrayed in the horizontal direction may be added to each other.

More specifically, charge signals of a plurality of pixels arrayed in at least one of the vertical direction (first direction) and horizontal direction (second direction) in the pixel array of the light receiving part 16a in the CCD 16 may be added to each other under the control of the camera controller 40. When adding charge signals to each other in this manner, some fields including at least two fields (e.g., “a” and “c” fields), one having the fewest defective pixels and the other having the second fewest defective pixels, among a plurality of fields (e.g., three) are designated as readout fields under the control of the camera controller 40. Then, at the time of image capturing, charge signals of the respective fields (“a” and “c” fields in this case) included in the designated fields may be added to each other.

However, as shown in FIG. 11, in the CCD 16 from which charge signals accumulated in the light receiving part 16a having the pixel array divided into five fields can be read out, it is more effective for reducing moiré to add charge signals of pixels located at a slight distance, rather than pixels located very close to each other.

For instance, as shown in FIG. 11, in the case of adding charge signals of pixels respectively belonging to the “a” and “c” fields arrayed in the vertical direction to each other, charge signals of pixels only two lines away from each other in the vertical direction are added. In contrast, in the case of adding charge signals of pixels respectively belonging to the “a” and “e” fields arrayed in the vertical direction to each other, charge signals of pixels four lines away from each other are added. In such case, it is more effective for reducing moiré to add charge signals between the “a” and “e” fields, rather than between the “a” and “c” fields.

Accordingly, since it may be disadvantageous for the purpose of reducing moiré to add charge signals between a plurality of fields having the fewest defective pixels, an arrangement may be considered taking into account the balance between reduction of moiré and reduction of the influence of point defects.

For instance, the following arrangement may be considered. There show up extremely few point defects in a field having a smaller amount defective pixels than a predetermined threshold value. Accordingly, a combination of fields effective for reduction of moiré is previously recorded on a ROM or the like. When there are many fields each having an amount of defective pixels smaller than the predetermined threshold value (less defective fields), charge signals are added in accordance with the combination of fields effective for moiré reduction among the less defective fields, placing importance on reduction of moiré, to generate a captured image. On the other hand, when there is no or only one less defective field, charge signals are simply added to each other between two fields having the fewest defective pixels and the second fewest defective pixels, placing importance on reduction of the influence of point defects, to generate a captured image.

In the above description, importance is placed on reduction of moiréor reduction of the influence of point defects depending on the predetermined threshold value according to necessary. However, this is only an illustrative example, and importance may be placed either on reduction of moiré or reduction of the influence of point defects by a user's operation of a predetermined operating section included in a camera operation part 50 according to necessary.

Further, in the above-described preferred embodiment, charge signals are read out from one least defective field among the plurality of fields in the live view mode or the like, to generate a live view image, however, this is only an illustrative example. In the case where generation of a live view image requires a quarter of horizontal lines included in one field, charge signals may be read out from one in every four horizontal lines in the least defective field in the CCD 16. More specifically, in the case where the “a” field is the least defective field among the “a” to “c” fields shown in FIG. 7, three in every four horizontal lines may be skipped when reading out charge signals from the “a” field.

In this case, however, pixels from which charge signals are to be actually read out are some of many pixels included in one field. Accordingly, for example, in the case of reading out charge signals from one field while skipping three in every four lines as described above, it is more important whether there are few defective pixels in a field obtained by skipping three in every four lines (also referred to as a “line-skipped field”), rather than whether there are few defective pixels in one field as compared to another.

Accordingly, since each of the “a” to “c” fields includes four line-skipped fields taking into consideration skipping of three in every four lines at the time of, for example, live view display or the like, one of twelve line-skipped fields in total that has the fewest defective pixels (least defective line-skipped field) may be designated as a readout field, and charge signals may be read out only from the least defective line-skipped field, to generate a captured image.

With such arrangement, an image less affected by point defects can be obtained at high speeds in accordance with a required image size.

Further, in the above-described preferred embodiment, point defects are detected with the timing of turning off the image capturing apparatus 1, however, this is only an illustrative example. The image capturing apparatus 1 may be configured to have a calendar function to judge whether or not a predetermined time period (e.g., 30 days) has passed after previous detection of point defects, and to exert control to detect point defects when 30 days have passed.

Furthermore, in the above-described preferred embodiment, the amount of point defects, i.e., defective pixels is measured in each of the fields to judge the amount of defective pixels in each field, however, this is only an illustrative example. For instance, importance may be placed on a predetermined area (e.g., an area around the central zone) in the pixel array of the light receiving part 16a in which the influence of point defects easily stands out so that the amount of defective pixels in each filed is detected.

Such arrangement can be achieved as shown in FIG. 13 in an image capturing apparatus 1B having the camera controller 40 shown in FIG. 2 provided with an additional function of assigning weights to the amount of defective pixels of a predetermined area to judge the amount of defective pixels (weighting calculation function).

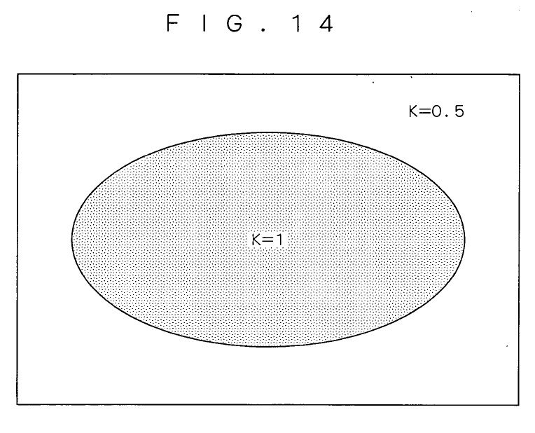

For instance, in each field, the number of defective pixels of the area around the central zone of the pixel array of the light receiving part 16a and the number of defective pixels of another area (peripheral area) are multiplied by different coefficients K, respectively, by the weighting calculation function, as shown in FIG. 14, so that the amount of defective pixels is detected. More specifically, in the area around the central zone, the number of defective pixels which is a parameter indicating the amount of defective pixels is multiplied by the coefficient K=1, while the number of defective pixels of the peripheral area in the pixel array is multiplied by the coefficient K=0.5 (relatively smaller than the coefficient K=1). In this manner, by multiplying different coefficients, the parameter indicating the amount of defective pixels of the area around the central zone is emphasized more than the parameter indicating the amount of defective pixels of the peripheral area, so that the amount of defective pixels in each field can be detected.

With such arrangement, at least one field among a plurality of fields constituting the light receiving part 16a that has a relatively small number of defective pixels on the basis of the result of detection of the amount of defective pixels placing importance on the area around the central zone is designated as a readout field in predetermined image capturing modes including the MOVE mode and the like. Then, in the predetermined image capturing modes including the MOVE mode and the like, charge signals are read out only from the at least one field designated as the readout field, to generate a captured image.

With such arrangement, an image less affected by point defects can be obtained at high speeds while placing importance on an area where a main subject is present, such as an area around the central zone of a shooting range.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image capturing part including an imaging device having a light receiving part from which charge signals accumulated in said light receiving part can be read out, said light receiving part having a pixel array divided into a plurality of fields;
a memory for storing at least one location of a defective pixel in said imaging device;
a mode selector for selecting a predetermined image capturing mode from among a plurality of image capturing modes;
a designating part for designating at least one field among said plurality of fields that has a relatively small number of defective pixels on the basis of said at least one location of a defective pixel stored in said memory; and
a generator for generating a captured image only by using charge signals read out from said at least one field with said predetermined image capturing mode being selected.

2. The image capturing apparatus according to claim 1, wherein
said predetermined image capturing mode includes at least one of a motion picture capturing mode, a high-speed continuous-exposure mode and a live view mode.

3. The image capturing apparatus according to claim 1, further comprising:
a detector for detecting at least one current location of a defective pixel in said imaging device with predetermined timing; and
an updating part for updating said at least one location of a defective pixel stored in said memory to said at least one current location of a defective pixel detected by said detector.

4. The image capturing apparatus according to claim 1, further comprising
an adder for adding charge signals of a plurality of pixels arranged in at least one of a first direction and a second direction extending perpendicular to said first direction in a pixel array of said light receiving part, wherein
said at least one field at least includes a first field having the fewest defective pixels and a second field having the second fewest defective pixels among said plurality of fields, and
said adder adds charge signals of respective fields included in said at least one field, to each other.

5. The image capturing apparatus according to claim 1, wherein
said designating part includes:
a judging part for judging an amount of defective pixels in said plurality of fields placing importance on a parameter indicating an amount of defective pixels of a predetermined area in said pixel array of said light receiving part rather than a parameter indicating an amount of defective pixels of an area other than said predetermined area; and
a field designating part for designating said at least one field on the basis of a result of judgment made by said judging part.

6. The image capturing apparatus according to claim 5, wherein
said predetermined area is an area around a central zone of said pixel array of said light receiving part.

7. The image capturing apparatus according to claim 1, wherein
in said imaging device, a charge signal accumulated in said light receiving part can be read out from each of a plurality of areas obtained by dividing each of said plurality of fields,
said designating part designates an area among said plurality of areas that has a relatively small number of defective pixels on the basis of said at least one location of a defective pixel stored in said memory, and
said generator generates a captured image only by using charge signals read out from said area.

8. A computer software product including a recording medium in which computer-readable software programs are recorded, wherein said software programs directed to a computer-executable process of generating a captured image, said computer being built in an image capturing apparatus including an imaging device having a light receiving part from which charge signals accumulated in said light receiving part can be read out, said light receiving part having a pixel array divided into a plurality of fields,
said process comprises the steps of:
(a) storing at least one location of a defective pixel in said imaging device in a predetermined memory;
(b) selecting a predetermined image capturing mode from among a plurality of image capturing modes;
(c) designating at least one field among said plurality of fields that has a relatively small number of defective pixels on the basis of said at least one location of a defective pixel stored in said predetermined memory; and
(d) generating a captured image only by using charge signals read out from said at least one field with said predetermined image capturing mode being selected.

9. The computer software product according to claim 8, wherein
said predetermined image capturing mode includes at least one of a motion picture capturing mode, a high-speed continuous-exposure mode and a live view mode.

10. The computer software product according to claim 8, wherein
said process further comprises the steps of:
(e) detecting at least one current location of a defective pixel in said imaging device with predetermined timing; and
(f) updating said at least one location of a defective pixel stored in said predetermined memory to said at least one current location of a defective pixel detected in step (e).

11. The computer software product according to claim 8, wherein
said process further comprises the steps of
(g) adding charge signals of a plurality of pixels arranged in at least one of a first direction and a second direction extending perpendicular to said first direction in a pixel array of said light receiving part, wherein
said at least one field at least includes a first field having the fewest defective pixels and a second field having the second fewest defective pixels among said plurality of fields, and
said step (g) includes the step of adding charge signals of respective fields included in said at least one field, to each other.

12. The computer software product according to claim 8, wherein
said step (c) includes the steps of:
(c-1) judging an amount of defective pixels in said plurality of fields placing importance on a parameter indicating an amount of defective pixels of a predetermined area in said pixel array of said light receiving part rather than a parameter indicating an amount of defective pixels of an area other than said predetermined area; and
(c-2) designating said at least one field on the basis of a result of judgment made in said step (c-1).

13. The computer software product according to claim 12, wherein
said predetermined area is an area around a central zone of said pixel array of said light receiving part.

14. The computer software product according to claim 8, wherein
in said imaging device, a charge signal accumulated in said light receiving part can be read out from each of a plurality of areas obtained by dividing each of said plurality of fields,
said step (c) includes the step of designating an area among said plurality of areas that has a relatively small number of defective pixels on the basis of said at least one location of a defective pixel stored in said predetermined memory, and
said step (d) includes the step of generating a captured image only by using charge signals read out from said area.
